(19) United States
(12) Patent Application Publication
(10) Pub. No.: US 2007/0088583 A1
(43) Pub. Date: Apr. 19, 2007

(54) Autonomic workflow application program generator and method thereof

(75) Inventors: Cher-Jung Chen, Taipei (TW); Chien-Jung Chen, Taipei (TW); Jung-Hsiang Chen, Taipei (TW); Sheng-Huei Huang, Taipei (TW); Tze-Yu Wang, Taipei (TW)

Correspondence Address: BACON & THOMAS, PLLC, 625 SLATERS LANE, FOURTH FLOOR, ALEXANDRIA, VA, 22314, US

(73) Assignee: Synergy Business Solutions Inc.

(21) Appl. No.: 11/249,474

(22) Filed: Oct. 14, 2005

(51) Int. Cl. G06F 17/50

(52) U.S. Cl. 705/7

(57) ABSTRACT

The automatic workflow application program generator of this invention automatically generates workflow definition files to be executed in the computer system by including organization and role definition information, activity definition information and data entity information input by user. Users may input definitions and cite definitions of workflow, organization/role, activities and data entit in to complete development of workflow application programs. In the present invention, steps in inputting the related definition files may be conducted in sequential, parallel or alternative manners, selectively by the user. The present invention also provides method for generation of workflow application programs using the invented program generator.

### FIELD OF THE INVENTION

The present invention relates to an autonomic workflow application program generator and method to generate workflow application programs. The present invention provides an autonomous and dynamic system for developers to generate workflow application programs by defining workflow and its related organizations, roles, activities and data entities. Developers may give defines of these modules sequentially, in parallel or alternatively, according to their habits or according to their needs. This invention also provides a method for using the invented program generator to generate workflow application software.

### BACKGROUND OF THE INVENTION

In ordinary companies or institutions, such as an enterprise, there is a great need to computerize their daily operations. Such need grows along with the growth in size of the enterprise and the complicity of its daily operations. However, when a computerized system is developed, users may easily find it difficult for them to connect data generated from separate systems. For example, modules having similar features, such as the accounting system and the salary system, are not well connected and data generated by one module can not be shared by the other. In addition, in developing a computerized system, persons in charge of planning of the system and persons who develop the system belong to different departments of the enterprise. Communications and coordination between or among them thus consume substantial time and cost. For companies of relatively smaller sizes, they can either use package software or outsource the development of software. However, most package software systems don't perfectly satisfy the needs of ordinary users and outsourcing always comes out with relatively high cost for smaller size enterprises.

It is thus necessary to provide a developing tool for users to develop computerized systems autonomously and dynamically.

It is also necessary to provide a method and system for developing workflow application programs whereby developers may define workflows by generating related modules sequentially, in parallel or alternatively.

### OBJECTIVES OF THE INVENTION

The objective of this invention is to provide a developing tool for users to develop computerized systems autonomously and dynamically.

Another objective of this invention is to provide a method and system for developing workflow application programs whereby developers may define workflows by generating related modules sequentially, in parallel or alternatively.

### SUMMARY OF THE INVENTION

In order to realize the above and other objectives, in the present invention an autonomous workflow planning tool is provided. The automatic workflow application program generator of this invention provides such a workflow planning tool that developers may give definitions of modules of a workflow in a sequential, parallel or alternative manner, depending on their needs or their preference.

The automatic workflow application program generator of this invention accepts input parameters and other definition information relating to particular workflow, automatically generates files including definitions representing said workflow and stores said definition files for the execution of the computer system. The automatic workflow application program generator of this invention comprises:
an electronic operation device to accept user's input of parameters and other information relating to definitions of particular workflow application program, to generate definition files representing said workflow application program and to store said definition file for execution;
a user interface to provide a plurality of screen displays allowing user to input data and displaying results of processing of said electronic operation device;
a workflow definition module to provide at least one screen display in said user interface allowing user to input, revise or delete data relating to definition of said workflow, including:
   announcing name of said workflow and sequential relations between said workflow and other workflows;
   defining organization and/or roles to include users and/or supervisors in said workflow; and
   setting relations between said workflow and said organizations and/or roles, including connections between organizations/roles of said workflow and that of other workflows;
wherein announcing said workflow and defining said organization/role are conducted in sequence, in parallel or in alternation;
an activity definition module to provide at least one screen display in said user interface allowing user to input, revise or delete data relating to definition of activities to be included in said workflow, including:
   defining activities to be included in said workflow; and
   defining screen displays of said activities to be displayed in at least one displaying device;
wherein said activity definition module provides template screen displays for said activities for user to select; and
wherein defining said activities and defining said screen displays are conducted in sequence, in parallel or in alternation; and
a data entity definition module to provide at least one screen display in said user interface allowing user to input, revise or delete data relating to definition of data entities to be used by said workflow, including:
   defining data entities to be used by said workflow and said activities; and
   defining format and/or structure of said data;
wherein defining said data entities and defining said format/structure are conducted in sequence, in parallel or in alternation;
characterized in that said electronic operation device generates said workflow definition file by including said data relating to definition of said workflow, data relating to definition of said activities and data relating to definition of said data entities.

In addition, the present invention provides an automatic workflow application program generating method to use a computer system to generate definition files representing a particular workflow according to input parameters and other information relating to said workflow and to store said definition file for the execution of the computer system. The automatic workflow application program generating method of this invention comprises the steps of:
providing an electronic operation device to accept user's input of parameters and other information relating to definitions of particular workflow application program, to generate definition files representing said workflow application program and to store said definition file for execution;
providing a user interface to include a plurality of screen displays allowing user to input data and displaying results of processing of said electronic operation device;
accepting user input of data relating to definition of said workflow, including:
   announcing name of said workflow and sequential relations between said workflow and other workflows;
   defining organization and/or roles to include users and/or supervisors in said workflow; and
   setting relations between said workflow and said organizations and/or roles, including connections between organizations/roles of said workflow and that of other workflows;
wherein announcing said workflow and defining said organization/role are conducted in sequence, in parallel or in alternation;
accepting user input of data relating to definition of activities to be included in said workflow, including:
   defining activities to be included in said workflow; and
   defining screen displays of said activities to be displayed in at least one displaying device;
wherein said activity definition module provides template screen displays for said activities for user to select; and
wherein defining said activities and defining said screen displays are conducted in sequence, in parallel or in alternation; and
accepting user input of data relating to definition of data entities to be used by said workflow, including:
   defining data entities to be used by said workflow and said activities; and
   defining format and/or structure of said data;
wherein defining said data entities and defining said format/structure are conducted in sequence, in parallel or in alternation;
characterized in that said electronic operation device generates said workflow definition file by including said data relating to definition of said workflow, data relating to definition of said activities and data relating to definition of said data entities.

These and other objectives and advantages of this invention may be clearly understood from the detailed description by referring to the following drawings.

### BRIEF DESCRIPTION OF THE DRAWINGS

In the drawings,

FIG. 1 illustrates the block diagram of the automatic workflow application program generator of this invention.

FIG. 2 illustrates the flowchart of the automatic workflow application program generating method of this invention.

FIG. 3 shows the flowchart of an embodiment of method for generating workflow application program according to the present invention.

FIG. 4 shows the flowchart of another embodiment of method for generating workflow application program according to the present invention.

FIG. 5 shows the flowchart of a third embodiment of method for generating workflow application program according to the present invention.

FIG. 6 shows the flowchart of a further embodiment of method for generating workflow application program according to the present invention.

FIG. 7 shows the flow chart of an embodiment of designing a customer management system using the method for generating workflow application program of the present invention.

FIG. 8 shows the flow chart of another embodiment of designing a customer management system using the method for generating workflow application program of the present invention.

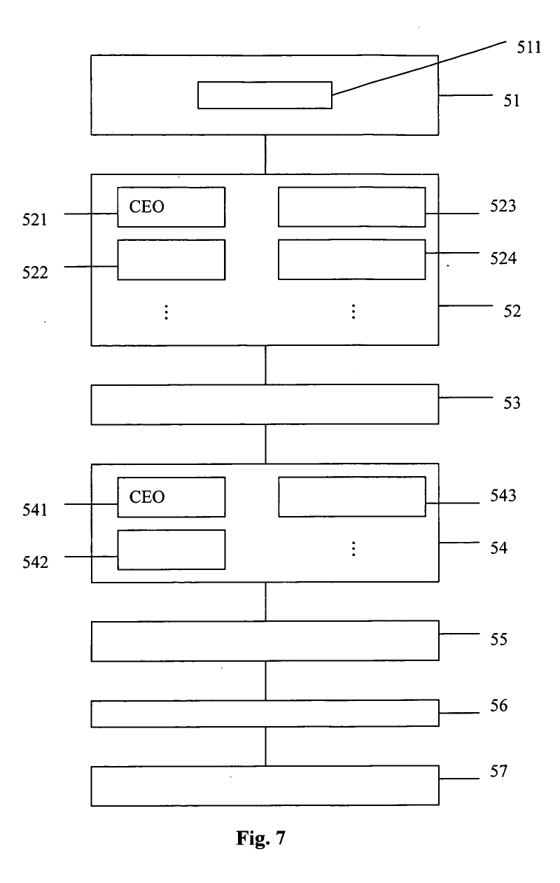

FIG. 7 shows the flow chart of an embodiment of designing a leave application procedure using the method for generating workflow application program of the present invention.

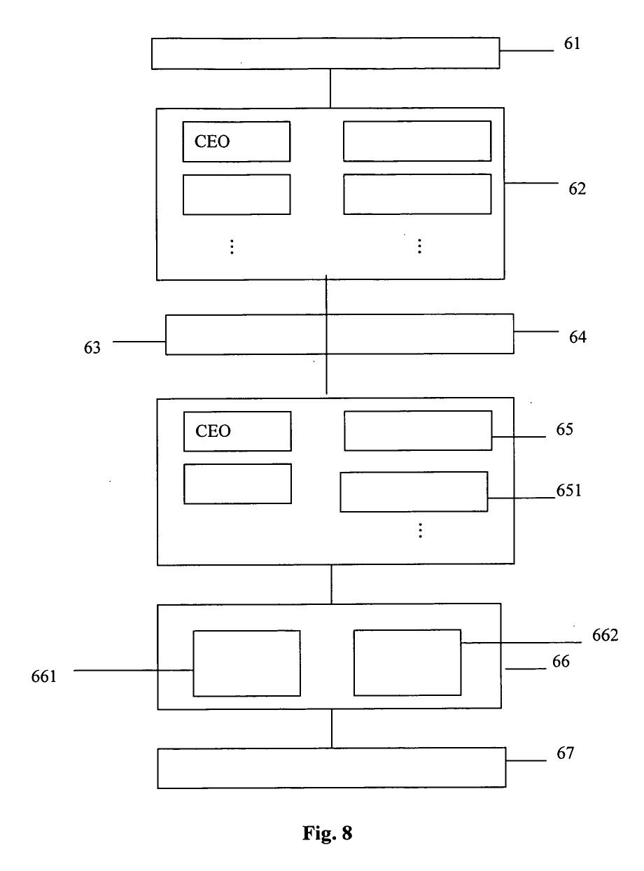

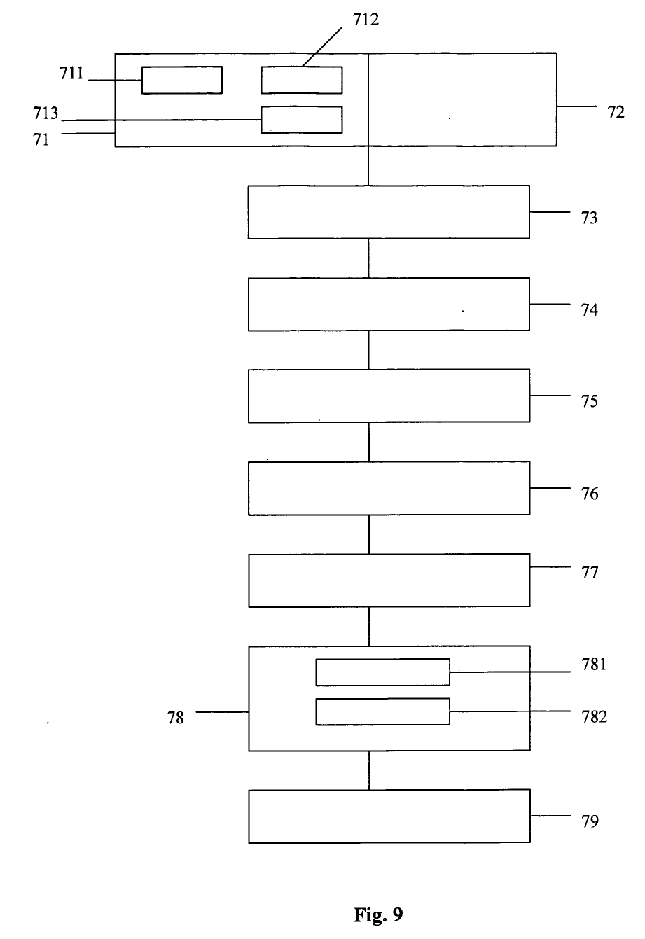

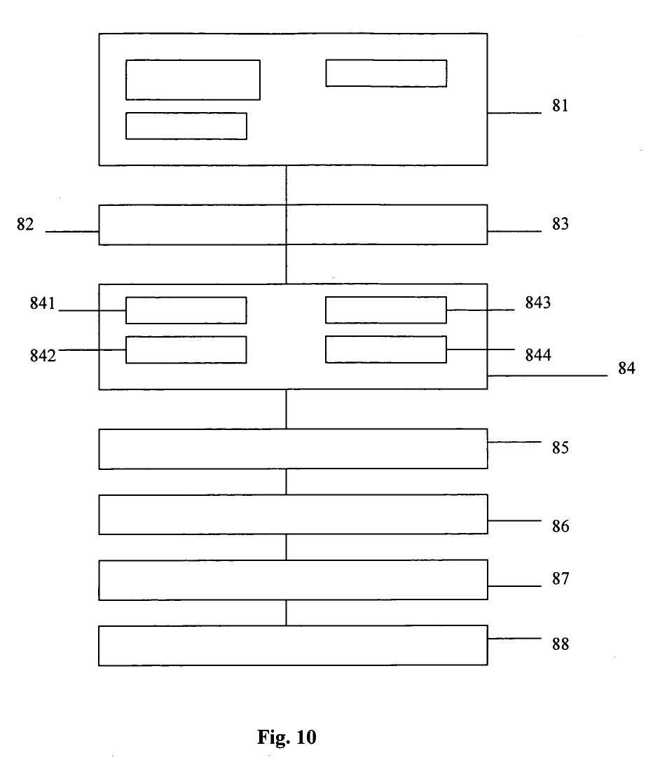

FIG. 8 shows the flow chart of another embodiment of designing a leave application procedure using the method for generating workflow application program of the present invention.

### DETAILED DESCRIPTION OF THE INVENTION

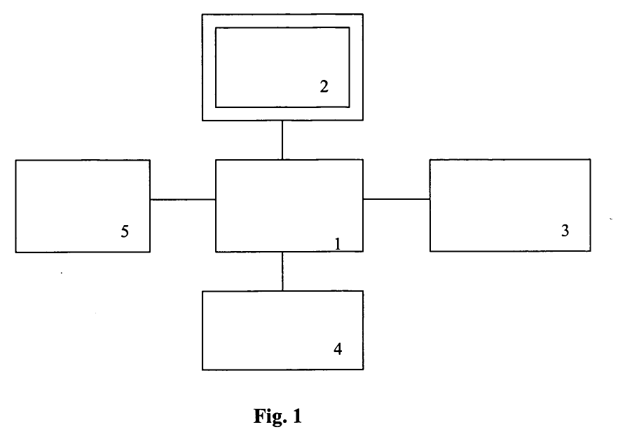

FIG. 1 illustrates the block diagram of the automatic workflow application program generator of this invention. As shown in this figure, the automatic workflow application program generator of this invention comprises:
an electronic operation device 1 to accept user's input of parameters and other information relating to definitions of particular workflow application program, to generate definition files representing said workflow application program and to store said definition file for execution;
a user interface 2 to provide a plurality of screen displays allowing user to input data and displaying results of processing of said electronic operation device;
a workflow definition module 3 to provide at least one screen display in said user interface allowing user to input, revise or delete data relating to definition of said workflow, including;
an activity definition module 4 to provide at least one screen display in said user interface allowing user to input, revise or delete data relating to definition of activities to be included in said workflow; and
a data entity definition module 5 to provide at least one screen display in said user interface allowing user to input, revise or delete data relating to definition of data entities to be used by said workflow.

In the above modules, the electronic operation device 1 may be any computer having high speed operation capabilities, including all kinds of personal computers, mini computers or servers. The user interface 2 may be a physical or virtual module installed in said electronic operation device 1 to allow users to input, revise or delete definition information relating to particular workflow application programs. The workflow definition module 3 may generate a plurality of screen displays and display the displays in the user interface 2, to allow user to input, revise or delete (hereinafter collectively referred to as “edit”) definition information of said particular workflow application programs. Here, definition information relating to the workflow application programs, editable by user, includes:
Name of said workflow and sequential relations between said workflow and other workflows;
Definition of organizations and/or roles, including users and/or supervisors in said workflow; and
Relations between said workflow and said organizations and/or roles, including connections between organizations/roles of said workflow and that of other workflows.

By using a known programming tool, those skilled in the art may realize a computer pogroms having these functions and execute the program in the electronic operation device 1 to obtain the workflow definition module 3 of this invention. Details thereof are thus omitted.

The activity definition module 4 may generate a plurality of screen displays in the user interface 2, allowing user to edit definition information for activities contained in the workflow application programs. The activity definition information editable by user includes:
Definition of activities to be included in said workflow; and
Definition of screen displays of said activities to be displayed in at least one displaying device.

To facilitate the edition, the activity definition module 4 may provide template screen displays for said activities for user to select.

By using a known programming tool, those skilled in the art may realize a computer pogroms having these functions and execute the program in the electronic operation device 1 to obtain the activity definition module 4 of this invention. Details thereof are thus omitted.

The data entity definition module 5 may generate a plurality of screen displays in the user interface 2, allowing user to edit definition information for activities contained in the workflow application programs. The activity definition information editable by user includes:
Definition of data entities to be used by said workflow and said activities; and
Definition of format and/or structure of said data.

By using a known programming tool, those skilled in the art may realize a computer pogroms having these functions and execute the program in the electronic operation device 1 to obtain the data entity definition module 5 of this invention. Details thereof are thus omitted.

In the present invention, the electronic operation device 1 generates the workflow definition file by including data relating to definition of the workflow, data relating to definition of the activities and data relating to definition of the data entities. The workflow definition file may thus be executed as a workflow application program by a conventional computer system to provide functions of regulating daily operations of an enterprise. By using a known programming tool, those skilled in the art may realize a computer pogroms having these functions and execute the application program in the electronic operation device 1.

The term “organization” as used above shall include all kinds of institute, their divisions and branches, e.g., a government branch, a foundation, a company etc., and relations between the branches and the divisions. Of course, if necessary external organizations and virtual organizations shall be included into this concept.

The terms “branches” and “divisions” as used above shall include all first level branches and divisions of an enterprise. For example, in a company there are administrative department, research and development department, marketing department etc. They may all be seen as branches and divisions in this invention. In addition, subordinating branches and divisions of these branches and divisions are also included in the concept of “branch” or “division”. For example, process technology R/D group, equipment technology R/D group, fundamental technology R/D group etc. of the R/D department shall all be seen as “divisions”. Furthermore, external branches and divisions, such as suppliers (companies) to R/D department and outside consultants and internal consultants are also branches and divisions of the organization. The term “subordinating branches and divisions” shall include multiple level subordinating branches and divisions. In the above example, the process technology R/D department may further include process R/D subdivision I, process R/D subdivision II etc. Similarly, the term “external branches and divisions” shall include indirectly related branches and divisions outside the enterprise. For example, for a procurement activity in the R/D department, its directly related division may be the administrative department. It's indirectly related division is procurement office subordinating to the administrative department. Supplier involved in this procurement activity is also seen as related external division. Of course, besides these first level branches and divisions, these subordinating branches and divisions and these related branches and divisions, there could be other branches or divisions, such as consulting group, ad hoc branches and divisions that are organized for particular purposes.

The term “relation between branches or divisions” shall include subordinating relation, such as in the above example R/D department is supervisor to process technology R/D department, whereby R/D department and process technology R/D department are in subordinating relation; parallel relation, such as in the above example R/D department and administrative department are in parallel relation; direct relation, such as in the above example, procurement division and supplier are in direct relation; and indirect relation, such as in the above example R/D department and supplier are indirect relation via procurement division. Of course, it is possible to define other relations, such as relations between R/D department and procurement division subordinating to administrative department.

The term “role” as used above shall include all kinds of positions in the branches and divisions. For example, in the organization of “president's office”, roles included in this organization are: president, vice presidents, secretary to president, special assistant to president etc. Roles shall include members of a branch or division, and their supervisors and subordinators.

The term “activity” as used above shall mean obligations of a role in a workflow, such as obligation to take training courses; work such as quality inspection activities by quality control employees, and submissions such as requesting a leave etc.

The term “data entity” as used above shall include data, such as R/D reports by R/D employees, and information, such as information obtained as results of a search, which are collectively referred to as “data” hereinafter, when related to respective activities.

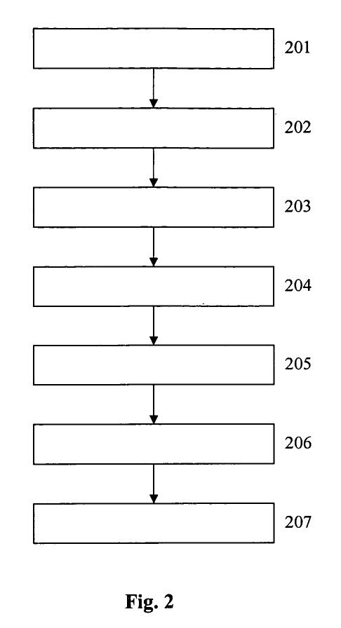

FIG. 2 illustrates the flowchart of the method for generating workflow application program of this invention. As shown in this figure, the method for generating workflow application program of this invention comprises using an electronic operation system to automatically generate a definition file representing a workflow application program and to store the workflow definition file for the execution by a computer system. The workflow definition file so generated includes workflow definition information, activity definition information and data entity definition information. In generating the workflow definition file, the following steps are used: At 201 an electronic operation system is provided, allowing user to input parameters and other definition information relating to a particular workflow. At 202 a user interface including a plurality of screen displays is provided to allow user to edit (input, revise and delete) information and to display results of processing. At 203 the electronic operation system accepts user's input of definition information of said work flow. At 204 the electronic operation system accepts user's input of definition information of activities to be included in said work flow. At 205 the electronic operation system accepts user's input of definition information of data entities to be included in said work flow. At 206 a workflow definition file is generated to include said workflow definition information, said activity information and said data entity information. At 207 the workflow definition file so generated is stored for further execution.

Under the design of this invention, the definition information relating to the workflow application programs includes: Name of said workflow and sequential relations between said workflow and other workflows; definition of organizations and/or roles, including users and/or supervisors in said workflow; and relations between said workflow and said organizations and/or roles, including connections between organizations/roles of said workflow and that of other workflows.

The activity definition information input by user includes: Definition of activities to be included in said workflow; and definition of screen displays of said activities to be displayed in at least one displaying device. To facilitate the edition, a plurality of template screen displays for said activities may be provided for user to select.

The activity definition information editable by user includes: Definition of data entities to be used by said workflow and said activities; and definition of format and/or structure of said data.

The term “defining work flows” shall mean generating work flowcharts to define work flows and sequences of respective work flows, which definitions and sequences form rules of respective works. Examples of work flows include: flows and sequences in submitting and approving a leave, in customer management system, in submitting and approving a payment, in evaluation of performance, in scheduling classes in a school, in a membership management system etc. Definitions of the flows and the sequences shall be clear and precise so that the organization and the related members are easy to understand. Work flowcharts are provided to prove the correctness and rationality of the total work flow. Understanding to and revisions of the work flows are thus made easy. Take the work flow for purchasing R/D equipment as example.

Also under the design of this invention, announcing said workflow and defining said organization/role in providing definitions relating to said work flow, defining said activities and defining said screen displays in providing definitions relating to said activity, and defining said data entities and defining said format/structure in providing definitions relating to said data entities, all may be conducted in sequence, in parallel or in alternation;

The term “defining organization and/or role” means: defining organizations participating in particular workflow and level where respective organizations belong. Definitions of organization may be planed, designed and adjusted according to the actual enterprise structure or the management schematics. Users and/or supervisors of respective workflows shall be ascertained, wherein names of user or supervisor may be assigned by a supervisor or jointly by members of the same organization. The users or the supervisor may also be assigned a higher level organization.

Taking defining organizations and/or roles for the “procurement department” as an example, related information of the definition is shown as follows:

| Procedure | Organization/Roles |
|---|---|
| Prescription of | R/D Depart. (Manager) |
| Specifications | |
| Request for procurement | R/D Dept. (Manager)→President |
| | Office (President) |
| Approval | (President)→(Manager/ |
| | Administrative Dept.)→ |
| | (Purchaser) |
| Price investigation | Procurement Dept. (Purchaser) |
| Budget determination | Administrative Depart. (Manager) |
| Public offering | Procurement Dept. (Purchaser) |
| Examination of suppliers' | R/D Dept. (Manager) |
| proposal | |
| Examination of suppliers' | Procurement Dept. (Purchaser) |
| offered price | |
| Selection of supplier | Administrative Dept. (Manager) |
| | jointly with R/D |
| | Dept. (Manager) |
| Contracting | Procurement Dept. (Purchaser) |
| Acceptance tests | R/D Dept. (R/D engineer) |

The term “defining an activity” shall mean defining substantial content of and/or relations between flows of respective workflow, including defining screen display as first step to display content of said workflow in the display device, enabling users to understand and to observe contents to be filled in for respective workflow; and defining relations between particular workflow and respective activities to be included in the workflow.

In the above instance, in defining activities for the procurements of R/D equipments, the following workflows shall have their respective activities as follows:

| Procedure | Activities (Screen Display) |
|---|---|
| Prescription of | Specification chart, containing, |
| Specifications | e.g., columns including items |
| | to be purchased, specifications, |
| | special requests etc. |
| Request for procurement | Application form, containing, |
| | e.g., columns including |
| | products to be purchased, |
| | explanations, approval etc. |
| Approval | Written approval form, contain- |
| | ing, e.g., columns including |
| | actions to be taken, departments |
| | to be consulted etc. |
| Price investigation | Written request of proformal |
| | invoice, containing, e.g., |
| | columns including products |
| | to be purchased, required |
| | specifications, offering |
| | price etc. |
| Budget determination | Budget chart, containing, e.g., |
| | columns including products to |
| | be purchased, specifications, |
| | special requests, suppliers' |
| | offers and acceptable price etc. |
| Public offering | Offering sheet, containing, e.g., |
| | columns including products |
| | to be purchased. |
| Examination of | Checklist of specifications, |
| suppliers' proposal | containing, e.g., columns |
| | including products to be purchased, |
| | specifications, special |
| | requests and conclusion |
| Examination of | Examination sheet, containing, |
| suppliers' offered price | e.g., columns including |
| | products to be purchased, |
| | specifications, special requests |
| | and conclusion |
| Selection of supplier | Conclusion form, containing, |
| | e.g., columns including |
| | products to be purchased, |
| | specifications, special requests, |
| | offered price etc |
| Contracting | Purchase contract, containing, |
| | e.g., columns including parties |
| | of contract, content of contract etc. |
| Acceptance tests | Acceptance form, containing, |
| | e.g., columns including |
| | products to be tested, conclusion etc. |

In the above, the term “defining data entity” shall mean defining data format and/or structure of data to be included in a particular workflow, so to ensure correctness of input/output of data; and defining data entities needed in respective workflows and/or activities, so that they may be used properly. For example, in the specification chart which is to be defined in the step of “prescription of specification”, as shown above, columns “items to be purchased” and “specifications” are defined as text data and column “special requests” may be any applicable format. For example, if the special request is to display the data, they are in text format. If it relates to test results, its format would be like AB±C, wherein A is numeric, B represents unit and C is tolerance, which is numeric.

In the above-described steps, definition of workflow, definition of activities and definition of data entities by all be realized by using commercially available computer software, such as Word and/or customer designed programs, such as those written in C language. Preferably the definitions are completed by using an editing environment designed by a customer designed program.

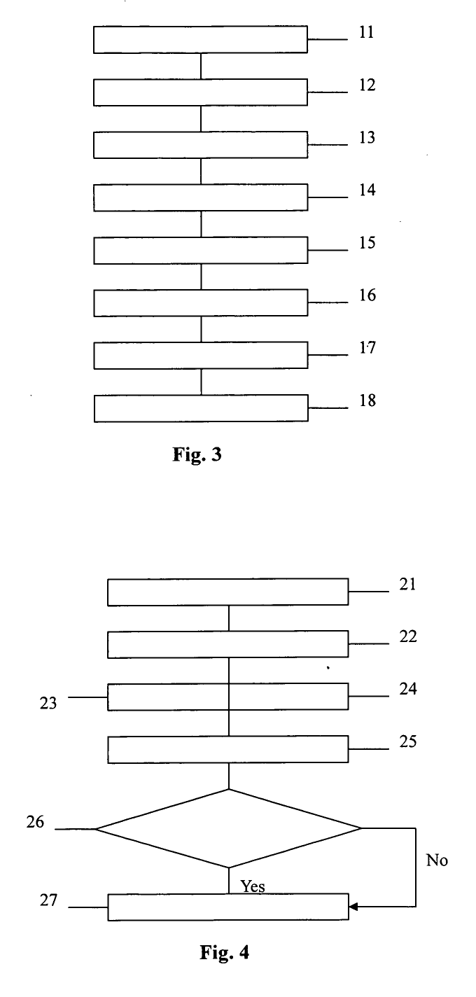

Now refer to FIGS. 3-6 which pertain to respective software development flows using the automatic workflow application program generator and method of this invention. FIGS. 3-6 respectively show the flowcharts in defining a workflow, including defining an organization and/or a role, in defining a screen display in defining an activity and in defining data entities. In giving all these definitions, all steps may be preceded sequentially, in parallel or alternatively, depending on the need of the designer.

In FIG. 3, a work flowchart is first prepared at 11. Then in a sequence, definition of organization and/or roles are given in 12, connections of work flows and organization and/or roles are given in 13, definition of screen display is given in 14, connections of work flows activity are defined in 15, definitions of data format and/or structure are given at 16, definitions to data entities needed in work flows and/or activity are given at 17 and connections of activity and data entities are given at 18.

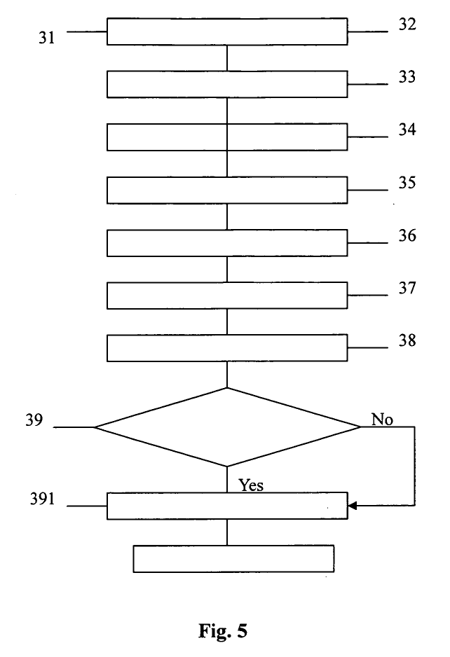

In the development flow as shown in FIG. 4, a work flow is first defined at 21. Then in a sequence, definition of organization and/or members are given in 22, definitions of activity and data entities are given at 23 and 24 at the same time respectively, and definitions to organization and/or members are modified at 25. After the modification, connections of work flows and organization and/or roles may be given at 26 and thus connections of work flows and organization and/or roles may be redirected at 27, all depending on the necessity. Of course, it is possible to add a step to define the connections between organization and/or roles and screen display, depending on actual necessity.

In the develop flow as shown in FIG. 5, first work flowchart is defined 31 and, at the same time, organization and/or roles are defined at 32, respectively. Then in a sequence, connections of work flowchart and organization and/or roles are defined at 33, screen display is defined at 34, connections of work flows and activity are defined at 35 data format and/or structure is defined at 36 and data entities needed by work flows and/or activity are defined at 37. After these steps, screen display may be modified at 38 and, depending on actual needs, connections between work flows and activity may be modified at 39 so that connections between work flows and activity are modified at 391.

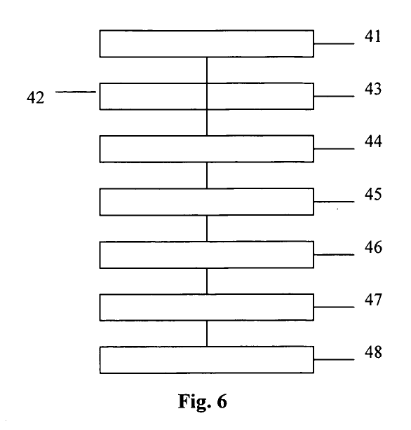

As to the develop flow as shown in FIG. 6, at first work flowchart is defined at 41. Then screen is defined at 42 and, at the same time, organization and/or roles are defined at 43, respectively. Then as a sequence, work flow chart is modified at 44, connections between work flowchart and roles are defined at 45, connection between work flowchart and activity is defined at 46, data format and/or structure is defined at 4 and data entities needed in work flows and/or activity are defined at 48.

As show above, in the autonomous flow planning system of the present invention, all definition steps may be used in sequence, in parallel or in alternation, all depending on actual needs in the development.

Nevertheless, the develop flow under the present invention may be conducted in a computer or partially in a personal digital aid (PDA). Steps such as definition of work flows and definition of organization and roles may be designed in a PDA and uploaded to the computer system to be integrated. A convenient and efficient development tool is thus developed.

### EMBODIMENTS

### Embodiment I

The first embodiment of the automatic workflow application program generator and method of the present invention relates to develop of a customer management system. Now refer to FIG. 3 and FIG. 7. A customer management system assists sales persons to manage all correspondences with the customers, including basic information of customer, contact persons, responsible persons for business etc. In addition, such system also provides classification of customers, wherein each class contains sectional objectives. User may record or review progresses of respective sectional objectives in order to perform best management of customers.

As shown in FIG. 7, workflow for the customer management system is first defined using an editing tool at 51. In this embodiment, the work flow is in fact an independent step, which includes a plurality of complicated operations. However, when defining the work flows of the customer management system using the automatic workflow application program generator and method of the present invention, only a single node flow 511 to represent this step is needed. As a result, under the present invention, a single node flow 511 is sufficient to represent complicated work sequences of a customer management system.

After the workflow is defined, organization and/or roles in the customer management system are then defined at 52. Here, members who are authorized to use the customer management system, their positions and tiles are defined. As shown in this figure, organizations and members allowed to use the system include CEO 521, President 522, technology research and development center 523 and operation and development center 524. Organizations and/or roles already defined may also be included. Connections between workflows and organization and/or roles are defined at 53.

Then activities needed in the customer management system are defined at 54. An editing environment designed using C language is given to provide necessary tools. Screen displays needed in the customer management system are defined. They are: general information 541, exclusive page for managers of sales department 542 and customer name 543. It is also possible to define connections between work flows and activity by using already defined activities at 55.

Data entities needed in the customer management system are defined at 56. Data entities needed in the customer management system and data formats and/or structure of such data entities are defined in this step.

Connections between activity and data entities are defined according to included data entities at 57. At this step, all actions using these elements are defined. They are: data entities used by the element, incidents to be trigged by the elements etc. Functions of the customer management system are completed under the above-said editing environment.

### Embodiment II

The second embodiment of the automatic workflow application program generator and method of the present invention relates to development of another customer management system. Please refer to FIGS. 4 and 8. The differences between this embodiment and Embodiment I are: after the workflow of the customer management system is defined at 61 and the organization and/or members of the system are defined at 62, activity of the system and data entities used in the system are defined in parallel at 63 and 64, respectively. After these steps, complying to special requests for the system, a step to modify definitions given to organization and/or roles at 65 is added. This enables the developed system to comply with changes in organization or roles. Data modification such as setting basic information and role of project manager 651 at 661 and 662, are conducted at 66. At last, connections between work flows and role (project manager 651) are defined. The system is thus completed.

### Embodiment III

The third embodiment of the autonomous flow planning system of the present invention relates to develop of a leave application procedure used in any enterprise or institution. Generally speaking, a leave is approved by a competent level according to number of days of the leave.

Please refer to FIGS. 5 and 9. At first the leave application workflow is defined by using the above-said editing tool at 71, so that workflow of a leave application is determined. The workflow includes: decision by superiority at 711, notices of rejection 712 and approval 713. In defining the workflow at 71, organizations and/or roles involved in the procedure are defined at the same time at 72. Participants and supervisors in the procedure are thus defined. In doing so, members in related organizations and title and position of their supervisors are connected.

When the workflow is defined at 71 and organization and/or roles are defined at 72 connections between workflow and organization and/or roles are defined. This includes handing over between organizations and roles. Connections between supervisors in leave application procedure and workflow are thus defined at 73.

Thereafter, activities are defined. Substantial content and/or connections of the workflow shall be defined. Screen displays are defined using the above-said editing tool at 74. Patterns of display using in the procedure are thus determined, whereby necessary information and approval form are displayed in the screen.

After the display is settled at 74, connections between the workflow and its activities are defined at 75.

Then data entities used in the leave application procedure are defined at 76. In this step, information necessary in the activity is used to determine respective workflow and/or data entities needed in respective activities and data format and/or structure of such data entities. At 77 define connections between activities of the leave application and the needed data entities according to data entities to be included. All activities using the elements are thus defined. They include: data entities needed by the elements and incidents to be trigged by the elements etc. The C language may be used to prepare a tool to realize such functions.

In addition, after the above settings are complete, if the screen display of the leave application procedure is not perfect, the screen may be redefined at 78. For example, calendar set 781 and situation 782 may be added. Connections between workflow and activities may need modification accordingly, whereby connections between them are redefined at 79.

### Embodiment IV

Now refer to FIGS. 6 and 10, which depict the fourth embodiment of this invention. This embodiment shows development of another leave application procedure. The differences between this embodiment and that of the third embodiment are that, after the workflow is defined at 81, screen display is defined at 82 and organization and/or roles in the procedure are defined at 83 at the same time and that a step of obtaining consent of deputy person at 841 is added. As a consequence, modification to the workflow is conducted at 84 to include the consent of competent deputy 841. Thereafter, the application is reviewed by supervisor at 842 and results of the review, either approved or rejected, are notified to applicant at 843 and 844, respectively.

After the flow is modified at 84, connections between workflow and roles are defined at 85, connections between workflow and activities are defined at 86, data format and/or data structure in the procedure is defined at 87 and data entities used in the workflow and/or activities are defined at 88.

As described above, the automatic workflow application program generator and method of the present invention provides speedy and dynamic work flow planning functions to users.

What is claimed is:

1. An automatic workflow application program generator, comprising:
an electronic operation device to accept user's input of parameters and other information relating to definitions of particular workflow application program, to generate definition files representing said workflow application program and to store said definition file for execution;
a user interface to provide a plurality of screen displays allowing user to input data and displaying results of processing of said electronic operation device;
a workflow definition module to provide at least one screen display in said user interface allowing user to input, revise or delete data relating to definition of said workflow;
an activity definition module to provide at least one screen display in said user interface allowing user to input, revise or delete data relating to definition of activities to be included in said workflow; and
a data entity definition module to provide at least one screen display in said user interface allowing user to input, revise or delete data relating to definition of data entities to be used by said workflow;
characterized in that said electronic operation device generates said workflow definition file by including said data relating to definition of said workflow, data relating to definition of said activities and data relating to definition of said data entities.

2. The automatic workflow application program generator according to claim 1, wherein said data relating to definition of said workflow includes:
name of said workflow and sequential relations between said workflow and other workflows;
organization and/or roles to include users and/or supervisors in said workflow; and
relations between said workflow and said organizations and/or roles, including connections between organizations/roles of said workflow and that of other workflows.

3. The automatic workflow application program generator according to claim 1, wherein said data relating to definition of said activities includes:
activities to be included in said workflow; and
screen displays of said activities to be displayed in at least one displaying device;
wherein said activity definition module provides template screen displays for said activities for user to select.

4. The automatic workflow application program generator according to claim 1, wherein said data relating to definition of said data entities includes:
data entities to be used by said workflow and said activities; and
format and/or structure of said data.

5. A method to automatically generating a workflow application program, to use an electronic operation system to generate definition files representing workflows according to parameters and other definition information input by user and to store said definition file for execution, comprising the steps of
providing an electronic operation device to accept user's input of parameters and other information relating to definitions of particular workflow application program;
providing a user interface to include a plurality of screen displays allowing user to input data and displaying results of processing of said electronic operation device;
accepting user input of data relating to definition of said workflow;
accepting user input of data relating to definition of activities to be included in said workflow; and
accepting user input of data relating to definition of data entities to be used by said workflow;
characterized in that said electronic operation device generates said workflow definition file by including said data relating to definition of said workflow, data relating to definition of said activities and data relating to definition of said data entities.

6. Method according to claim 5, wherein said data relating to definition of said workflow includes:
name of said workflow and sequential relations between said workflow and other workflows;
organization and/or roles to include users and/or supervisors in said workflow; and
relations between said workflow and said organizations and/or roles, including connections between organizations/roles of said workflow and that of other workflows.

7. Method according to claim 5, wherein said data relating to definition of said activities includes:
activities to be included in said workflow; and
screen displays of said activities to be displayed in at least one displaying device.

8. Method according to claim 5, wherein said data relating to definition of said data entities includes:
data entities to be used by said workflow and said activities; and
format and/or structure of said data;

9. Method according to claim 6, wherein announcing said workflow and defining said organization/role are conducted in sequence, in parallel or in alternation.

10. Method according to claim 7, wherein defining said activities and defining said screen displays are conducted in sequence, in parallel or in alternation.

11. Method according to claim 8, wherein defining said data entities and defining said format/structure are conducted in sequence, in parallel or in alternation.

12. The automatic workflow application program generator according to claim 2, wherein said role includes supervisor.

13. The Method according to claim 6, wherein said organization includes divisions in an institute.

14. The Method according to claim 6, wherein said organization includes divisions in an institute.
